(19) United States
(12) Patent Application Publication
(10) Pub. No.: US 2025/0232664 A1
(43) Pub. Date: Jul. 17, 2025

(54) METHOD AND SYSTEM FOR PROVIDING ASSISTANCE IN VEHICLE ACCIDENTS

(71) Applicant: ATRESSA GLOBAL CORPORATION, S.L., DERIO (BIZKAIA) (ES)

(72) Inventor: César BASTERRECHEA SÁNCHEZ, DERIO (BIZKAIA) (ES)

(73) Assignee: ATRESSA GLOBAL CORPORATION, S.L., DERIO (BIZKAIA) (ES)

(21) Appl. No.: 18/701,561

(22) PCT Filed: Oct. 14, 2021
(86) PCT No.: PCT/ES2021/070750

§ 371 Date: Apr. 15, 2024

(51) Int. Cl. G08B 25/01; G08B 25/00

(52) U.S. Cl. CPC G08B 25/016; G08B 25/005

(57) ABSTRACT

A method detects an accident, using accident sensors that measure vehicle traffic parameters, and establishes emergency actions to seek assistance and to collect audiovisual recordings of the accident, which are sent to a server, in a tamper-proof manner, and, optionally, to contacts of the user, or to authorities. The device includes the accident sensors, recording means, positioning means and sending means. The device includes a mobile application that manages the identification of the accident and the performance of emergency actions.

### CROSS-REFERENCE TO RELATED APPLICATIONS

This application is a national stage under 35 U.S.C. § 371 of PCT patent application PCT/ES2021/070750 filed on 14 Oct. 2021, which is pending and which is hereby incorporated by reference in its entirety for all purposes.

### TECHNICAL FIELD

The present invention is directed to the field of vehicle traffic flow, in particular with regard to traffic flow safety. In particular, the object of the invention relates to a method, and to a system, for providing assistance in cases of vehicle accidents, which are especially applicable, although not exclusively, in cases of accidents involving a cyclist.

### BACKGROUND OF THE INVENTION

There are different devices for detecting a collision, which are coupled to a bicycle or a cyclist's equipment (helmet, clothing, etc.). These devices usually communicate through a mobile application and send messages to contacts.

Moreover, there are a large number of action cameras that enable image recording while the cyclist is riding in traffic, storing the images, which the cyclist himself recovers when he or she wishes (after a trip, accident, etc.)

Among the devices and cameras described above, the following are known by way of example: Specialized ANGi crash sensor; Abus Quin; Cycliq Fly6; Citroën ConnectedCAM.

In the event of an accident, it is important to have as much data as possible: where it happened, what the environment is, the cyclist's condition, etc. For this, it is not enough to only have the position, it is also necessary to have images of the environment, how to access it, and even audio with sounds that can help the rescue. At the time of generating the notification it is important to associate this data and ensure that it is received by chosen people.

All these factors make known devices not compliant with safety requirements and/or costly, limiting the expansion and use thereof.

### DESCRIPTION OF THE INVENTION

The present invention resolves the aforementioned drawbacks by providing, according to a first aspect, a method for providing assistance in vehicle accidents, as well as, according to a second aspect, a system for providing assistance in vehicle accidents. The invention is particularly applicable to accidents involving vehicles the drivers of which are more vulnerable, for example, vehicles without a passenger compartment; more particularly, two-wheeled vehicles, such as bicycles, motorcycles, mopeds, electric scooters, etc., although it can also be extended to passenger cars and, in general, to vehicles of any type.

Briefly explained, the invention autonomously detects an accident situation of a vehicle driven by a driver user, and also carries out emergency actions to get assistance and to save audiovisual evidence of the accident. In particular, the present invention first identifies an accident situation of the vehicle, through accident sensors that take measurements of vehicle circulation parameters, which are evaluated according to pre-established criteria.

If an accident is identified, data is automatically sent to a server that includes: vehicle position, audio and video recordings prior to, during and after the accident and, optionally, the itinerary of the vehicle. This data, once received and stored on the server, is protected, since it cannot be manipulated, which makes it valid as evidence in the event of litigation. Additionally, the data can be sent, for example, from the server, to previously established persons or to the authorities (police, 112, etc.)

More specifically, once an accident has been identified, a first warning communication (such as an SMS, a WhatsApp message, etc.) is sent to a mobile device (such as a mobile phone) of one or more preselected contacts from a mobile device (generally a mobile phone) of the driver user, to seek assistance, wherein the first warning communication reports relevant aspects of the accident, such as: it identifies the driver user, and indicates the existence of the accident, the position of the vehicle involved in the accident and, optionally, especially in the case of users driving the aforementioned two-wheeled vehicles, the itinerary travelled by said vehicle. Likewise, in a similar manner, a second warning communication can also be sent to an authority, such as the Police or an emergency number, depending on availability of communication with the authority, also reporting the existence of an accident and indicating relevant aspects related thereto, in order to seek assistance.

Furthermore, the invention also makes it possible to take an audio and video recording of the accident and send it, either directly or through the user's mobile phone, to a server, where it is stored as evidence, in a tamper-proof manner. Likewise, the audio and video recording can also be made accessible to the selected contact, to facilitate locating and assisting the user. In particular, “making accessible” is understood as, for example, sending a file with the recording, sending a link to the server location where the recording is stored, etc., wherein the link, if applicable, can be included in the first communication and, optionally, in the second communication.

All the data, as indicated above, preferably goes through a server, wherein the accident details, contact details, security and availability are guaranteed. The data is processed and made known to the people responsible for providing assistance in a very short time. If it is required as evidence in the future, it is also protected from manipulation by any interested party.

The invention envisages that the execution of emergency actions depends on a response from the user. For example, once an accident has been detected, and prior to executing the emergency actions, it proposes a cancellation action to the user, such as pressing a button or saying a certain word, before the end of a countdown. If the user cancels, by pressing the button or by saying the word, the accident is ruled out, so that emergency actions are not taken.

According to a preferred exemplary embodiment, the invention describes a system for providing assistance in accidents, comprising:
A capture device, preferably mounted on the vehicle, for example, on a bicycle, driven by the user, and which in turn includes:
   Accident sensors, connected to a control unit, to receive measurements related to vehicle traffic flow parameters from the accident sensors and, based on these measurements and based on one or more predetermined criteria, to detect the existence of an accident.
   Recording means, to take audio and video recordings around the vehicle.
   Broadcast means to retransmit the recordings.
A mobile device of the user, with the following functionalities:
   Positioning and, optionally, itinerary.
   Reception of recordings from the capture device.
   Retransmission of data to a server.

The invention is configured to use a server, which can optionally be part of the assistance system, and which has the following functionalities:
Storing contact details, such as contact details of the contacts of the user's mobile device and/or contact details of authorities, such as the Police or an emergency number.
Reporting the event to contacts and/or to the authorities.
Receiving and storing event data and recordings.
Providing access to the position of the accident and to the recordings.
Providing access to the vehicle's itinerary up until the accident.

By way of illustration, the accident is detected, for example, when the inclination, relative to the ground, of the vehicle, for example, a two-wheeled vehicle such as a bicycle, is kept outside a certain pre-established range (for example, it is less than a specific pre-established value) for a certain period of time. Video recording is preferably carried out by segments of a certain duration and at a speed equal to or greater than 90 fps to capture incidents that occurred in a short period of time. In the event of an accident, the cyclist is informed by means of a countdown notification, and if this countdown notification is not cancelled, the corresponding recording segments are sent through, for example, the GPRS network, to a server. The fragments that are recorded are saved in a memory of the system (either of the capture device or, where appropriate, of the user's mobile device) and are discarded if an accident is not detected.

Other optional features of the system of the invention relate to: detecting the position thereof on a support, so that it only works when it is installed on the support; incorporating warning lights for other drivers; incorporating a brake light with automatic activation; incorporating a theft alarm, by detecting movement when the vehicle has been left in “padlock” mode.

The present invention envisages operating under (or in collaboration with) a mobile application as an option. In particular, the system may include, jointly integrated, the device and the mobile, with corresponding connectivity, such as GPS +GSM and, where appropriate, GPRS. For example, a mobile device of a user may be available which provides the GPS service and GPRS connection and it can be used via Bluetooth or Wi-Fi as a bridge to the server with the use of the mobile application.

The server recognises the system and the data received and presents said data, for example, on a restricted consultation web page. In addition, it sends data messages to the people that the user has previously registered on the server in the event of an accident. The people who receive the message can access the data on the website and act to seek assistance.

The invention provides greater safety for the user, providing a system and a method that records images, sounds, positions and itineraries while driving, as well as detects the accident, selects data related to the moments surrounding the accident, stores said data in a safe and tamper-proof manner and sends it to the people responsible for carrying out a rescue.

The invention, therefore, enables facilitating a rescue to save the life of a user involved in an accident who may be unable to communicate, and also generates recordings that are admissible as legal evidence in the event there is a third party involved in the accident, since the memory of the system of the invention cannot be accessed by third parties, since the data passes, according to an example, to the user's mobile device by secure means, such as by Bluetooth (by pairing), and from the user's mobile device to the server also by secure means, such as an https web.

The passing of the data through the server guarantees the safety and availability of the accident details and contact details. This data is processed and, in a very short time, made known to the people responsible for providing assistance. If it is required as evidence in the future, it is also protected from manipulation by any interested party.

### BRIEF DESCRIPTION OF THE DRAWINGS

To complement the description provided herein, and for the purpose of helping to make the features of the invention more readily understandable, said description is accompanied by a set of drawings constituting an integral part of the same, which by way of illustration and not limitation represents the following:

FIG. 1 shows a configuration diagram of the invention according to a preferred exemplary embodiment in which a mobile application is included.

FIG. 2 shows an operating diagram of the invention.

FIG. 3 shows a front view of a capture device that is part of the system of the invention.

FIG. 4 shows a fixing detail of the capture device of FIG. 3 to a bicycle.

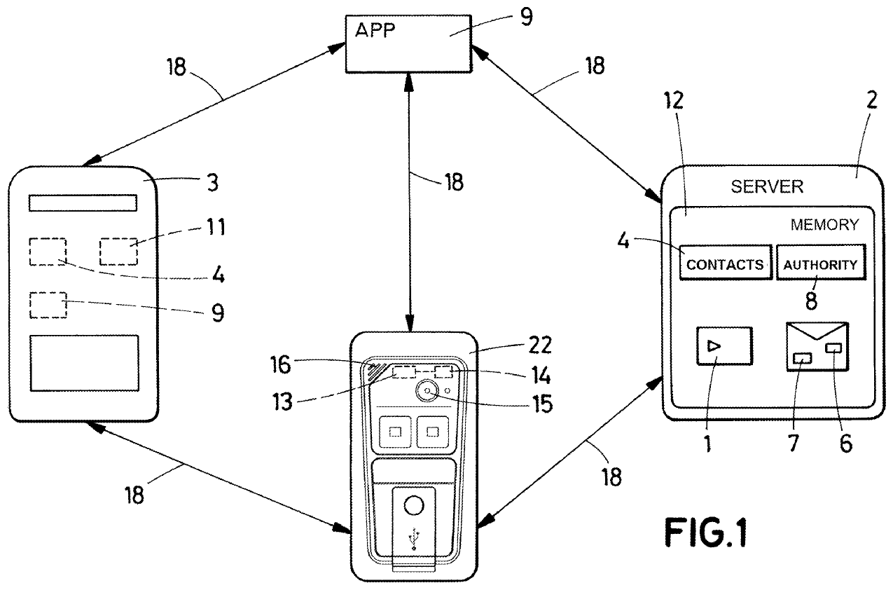

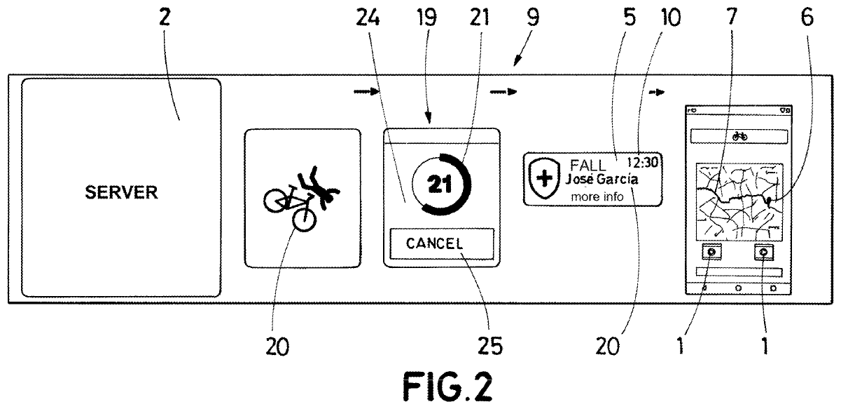

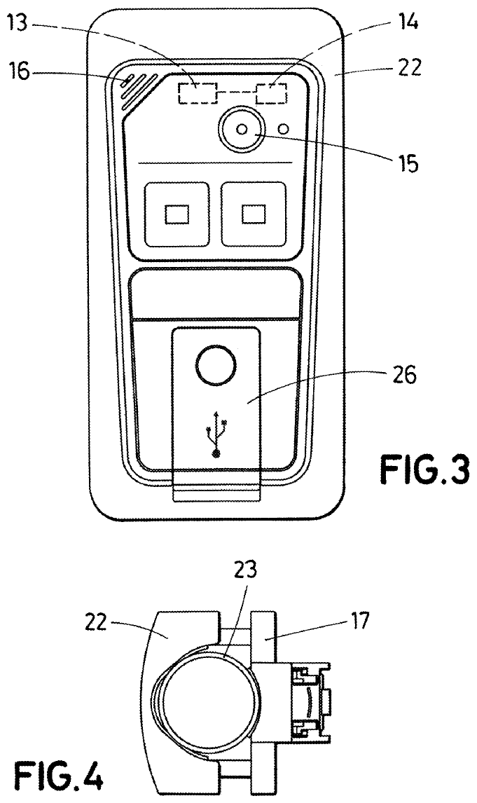

### LIST OF REFERENCES

1 Audiovisual images
2 Server
3 Mobile device (mobile phone)
4 Contacts
5 Warning communication
6 Position
7 Itinerary
8 Authority
9 Mobile application
10 Time
11 GPS
12 Memory
13 Accident sensors
14 Control unit
15 Camera
16 Microphone
17 Support
18 Broadcast means
19 Cancellation means
20 User
21 Countdown
22 First capture device
23 Post
24 Touch screen
25 Push button
26 Charging port

### PREFERRED EMBODIMENT OF THE INVENTION

In the following detailed description of the preferred embodiments, reference is made to accompanying drawings 1-4, wherein specific preferred embodiments in which the invention may be carried out are shown by way of illustration. These embodiments are described in sufficient detail to enable those skilled in the art to carry out the invention.

According to a first aspect, the invention relates to a method for providing assistance in accidents. According to a second aspect, it relates to a system for providing assistance in accidents which implements the preceding method. The method of the present invention automatically identifies an accident involving a user (20) who is a driver of a vehicle, for example, a cyclist, and initiates emergency actions comprising seeking assistance and collecting evidence of the accident.

The collection of evidence comprises capturing audiovisual recordings (1) of the accident, which can be both at moments prior to the accident and during the accident and even after the accident, and which are sent to a server (2), wherein they are stored as evidence to be displayed or sent, but without the possibility of being manipulated or altered.

The search for assistance comprises sending, from a mobile device (3) of the user (20), for example, a mobile phone (3), optionally through the server (2), to one or more contacts (4) previously registered in the mobile device (3), a warning communication (5) wherein the user (20) is identified, the fact that he has suffered an accident is indicated, the time (10) of the accident is indicated, and the position (6) of the accident and, optionally, the itinerary (7) travelled by the vehicle to the position (6) of the accident are shown. Likewise, optionally, the warning communication (5) can also be sent to an authority (8), for example, the Police and/or an Emergency Service, which has compatible communication means installed, for example, to receive messages such as SMS, WhatsApp, etc., or wherein a voice recording is generated with the necessary data, which is sent as a call (by phone, by WhatsApp, etc.) to the authority (8).

Emergency actions can be optionally run on the mobile device (3) of the user (20), under the control of a mobile application (9) installed on said mobile device (3) of the user (20), wherein the mobile application (9) has access to functionalities of the mobile device (3), such as: time (10), GPS (11), maps, contacts (4), voice recorder, camera, calls, messaging, etc., as well as a communication interface with the user (20) and a communication interface with the server (2).

In case of incorporating a mobile application (9), the mobile application (9) can take the contact details (4) of the mobile device (3) and record them in a memory (12) of the server (2), and manage, in the event of an accident, the sending of warning communications (5) and audiovisual recordings (1), where appropriate, through the server (2), to the contacts (4) and/or the authority (8).

To carry out the aforementioned actions for collecting evidence and seeking assistance, the invention comprises a system for providing assistance in vehicle accidents, as indicated above, and including the following components:
Accident sensors (13), which take data measurements of vehicle traffic flow parameters, selectable, for example, from one or more of the following: time, speed, acceleration, inclination with respect to the ground, height with respect to the ground, etc.
Control unit (14), which receives the measurements from the accident sensors (13) and, based on said measurements and predetermined criteria, identifies an accident situation, for example, if a deceleration value greater than a predetermined value or, especially for two-wheeled vehicles, an inclination below a predetermined value for a time greater than a predetermined value is detected.
Recording means (15, 16), to continuously take audiovisual recordings (1), in a vehicle environment, and which may include, for example: one or more cameras (15) with built-in microphone(s) (16); or camera(s) (15) connected to external microphone(s) (16). The recording means (15, 16) may be intended to be fixed to the vehicle and/or to be carried by the user him or herself (20), for example, fixed to garments (not shown) of the user (20), such as a jacket, helmet, etc. For example, the recording means (15, 16) can incorporate one or more of the cameras (15), arranged to be fixed to the vehicle, for example, to the bicycle, such that they are on one same support (17), and point in various directions with respect to travel (forward and/or backward and/or sideways, etc.).
Positioning means (11), such as GPS (11), to determine, in real time, position (6) and, optionally, itinerary (7) of the vehicle.
Broadcast means (18), to send the audiovisual recordings (1) and, where appropriate, the position (6) and, optionally, the itinerary (7), to the server (2), wherein they are stored as evidence to be displayed or sent, but without the possibility of being manipulated or altered. The server (2) can optionally be part of the invention. The broadcast means (18) also send warning communications (5) to the contacts (4) previously selected from the mobile device (3) carried by the user (20), or to an authority (8), such as the Police or an Emergency Service, wherein the warning communications (5) can be text messages (for example: SMS, WhatsApp, etc.) or voice calls with voice messages, and wherein the warning communications (5) contain data indicating that there is an accident, identifying the user (20) involved in an accident, the time (10) of the accident, and providing access to the location (6) and, where appropriate, to the itinerary (7) of the vehicle involved in the accident. Audiovisual recordings (1) and/or warning communications (5) can be sent from the mobile device (3) of the user (20) directly to a mobile device of the contacts (4) or to the authorities (8), or it can be done from the mobile device (3) of the user (20) to the server (2), and from the server (2) to the mobile devices of the contacts (4) or to the authorities (8), wherein the contacts (4) of the user (20) can be additionally stored in the memory (12) of the server (2).

Optionally, the system further includes cancellation means (19) which, once the accident situation has been detected—by the control unit (14) from the measurements of the accident sensors (13) and the pre-established criteria-they communicate with the mobile device (3) of the user (20) to request the user (20) a cancellation of emergency actions wherein, for example, emergency actions are only carried out if the user (20) does not cancel before the end of a countdown (21) that starts when the accident situation is identified.

Optionally, the system can further include the aforementioned mobile application (9), installed on the mobile device (3) of the user (20), and which has access to various functionalities of said mobile device (3) of the user (20), as well as has a user interface that interacts with the user (20), and communication with the server (2), all of this to control both the operation of the previously described components, as well as the management of emergency actions.

According to a first exemplary embodiment, the system comprises a first capture device (22) that integrates the accident sensors (13), the recording means (15, 16) and at least part of the broadcast means (18), while other components, such as the positioning means (11), are in the mobile device (3) of the user (20), with which the first capture device (22) communicates through communication means. The first capture device (22) is intended to be fixed, by means of a support (17), to the vehicle wherein, in the case of a two-wheeled vehicle (bicycle, motorcycle, moped, electric scooter, etc.) it is preferably intended to be fixed to the saddle, for example, to the saddle post (23), by means of the support (17).

The first capture device (22) is configured to carry out continuous measurements by means of the accident sensors (13), as well as to capture the audiovisual recordings (1) continuously through the recording means (15, 16), and send, through the broadcast means (18), said audiovisual recordings (1) to the server (2). Also, optionally, the first capture device (22) can include the cancellation means (19), for example, it can include a touch screen (24) wherein the user (20) presses to cancel, or recognition of a voice cancellation command (not shown) from the user (20), etc. Alternatively, the cancellation means (19) may be located on the mobile device (3) of the user (20), for example, to be deployed and managed through the mobile application (9). The control unit (14) can be indistinctly located in the first capture device (22), or in the mobile device (3) of the user (20), or form part of the mobile application (9).

According to a second exemplary embodiment, alternative to the first exemplary embodiment described above, the system comprises a second capture device (not shown), integrated together with the mobile device (3) of the user (20), so that it includes both the accident sensors (13), the recording means (15, 16) and at least part of the broadcast means (18), as well as additionally the positioning means (11) of the mobile device (3), the unit control (14) and, optionally, the cancellation means (19).

In a similar manner to the first capture device (22), the second capture device can be fixed to the vehicle or to the user (20).

Next, functionalities compatible with any of the first (22) and second capture devices are described, which will be referred to below as “the capture device (22)” or “the capture devices (22)”, interchangeably.

The capture devices (22) can include a power-on push button (25), as well as a charging port (26), such as of the USB type, to charge a built-in battery (not shown).

Likewise, the capture devices (22) include, as previously indicated, a digital microphone (16), and high-speed camera(s) (15), which can include front, rear and/or side cameras (15).

The capture devices (22) can, in a preferred exemplary embodiment intended for users (20) driving two-wheeled vehicles, which are more vulnerable, include, as indicated above, the support (17) to be fixed to the two-wheeled vehicle, such as to the saddle post (23) on a bicycle, or to other parts of the two-wheeled vehicle.

Likewise, the capture devices (22) can include luminous notifications (not shown), such as a position light, preferably flashing, as well as preferably able to be deactivated, for example, in group traffic flow, and/or a brake light (not shown), that is switched on when a deceleration is detected. In addition, it can include: an anti-theft alarm, with notification to the mobile device (3) of the user (20); a charge indicator; and protection against rain, for example, by means of IP56 degree of protection against moisture.

Preferably, the capture devices (22) can be configured so that, once connected, they remain on standby, with the functions suspended, if they lose contact (for example, due to being removed) with the support (17) to the vehicle, and optionally, finally turn off automatically after a pre-established time.

The preferred operation of the device, applied to two-wheeled vehicles, is briefly described below:

When an accident is identified, the capture device (22) starts a countdown (21) on the mobile device (3) of the user (20) (usually on their mobile phone), for example, through the mobile application (9). If the countdown (21) is cancelled by the user (20), the capture device (22) continues to operate in its normal state; otherwise, the preselected contacts (4) are informed, indicating the name of the user (20), the “accident”, “fall” or similar event, the time (10), and the audiovisual recordings (1), location (6) and itinerary (7) are sent to the server (2).

The capture device (22) can include battery management, with some of the following functionalities:
Continuously monitoring the battery charge level;
Switching off the capture device (22) if the battery level falls below a predetermined level for safety.
Switching off the capture device (22), if it is on, when connecting a charger.

The invention claimed is:

1.-17. (canceled)

18. A method for providing assistance in vehicle accidents, the method comprising the steps of:
detecting an accident situation of a vehicle driven by a driver user;
continuously taking audiovisual recordings of a vehicle environment; and
carrying out emergency actions including actions to get assistance and actions to send the audiovisual recordings to a server in a tamper-proof manner.

19. The method according to claim 18, wherein the audiovisual recordings comprise recordings prior to, simultaneous with, and after the accident.

20. The method according to claim 18, further comprising sending to the server one or more data selected from:
an identification of the user driving the vehicle involved in the accident;
an indication that the user has had an accident;
a position of the vehicle involved in the accident;
an itinerary of the vehicle up until the accident;
a time of the accident;
contact details of at least one contact included in a mobile device of the user; and
contact details of authorities.

21. The method according to claim 18, which includes an additional step of sending, to a contact registered in a mobile device of the user, or to an authority, one or more selected data from:
an identification of the user driving the vehicle involved in the accident;
an indication that the user has had an accident;
a time of the accident;
a position of the vehicle involved in the accident; and
itinerary of the vehicle up until the accident.

22. The method according to claim 20, wherein the data is previously stored in the server.

23. The method according to claim 19, which additionally includes a step of making the audiovisual recordings accessible to an authority or to a contact of a mobile device of the user.

24. The method according to claim 23, wherein the step of making the audiovisual recordings accessible is carried out from the server or from a mobile device of the user.

25. The method according to claim 18, further comprising an additional step of proposing to the user, after the accident is identified, a cancellation action, such that emergency actions are only carried out if the user does not carry out the cancellation action.

26. The method according to claim 18, wherein the step of detecting the accident situation in turn comprises the steps of:
taking measurements of vehicle circulation parameters; and
evaluating measurements according to pre-established criteria.

27. The method according to claim 26, wherein the criteria comprise maintaining, for a duration greater than a predetermined time, an inclination, with respect to the ground, of less than a predetermined value.

28. A system for performing a method of providing assistance in vehicle accidents, the method comprising the steps of:
detecting an accident situation of a vehicle driven by a driver user;
continuously taking audiovisual recordings of a vehicle environment; and
carrying out emergency actions including actions to get assistance and actions to send the audiovisual recordings to a server in a tamper-proof manner;
the system comprising:
accident sensors, which take data measurements of vehicle circulation parameters;
a control unit, which receives the measurements from the accident sensors and, based on said measurements and predetermined criteria, identifies an accident situation;
a recording means to continuously capture audiovisual recordings in a vehicle environment;
a positioning means to determine, in real time, position and itinerary of the vehicle; and
a broadcast means for sending the audiovisual recordings to a server to be displayed or sent without the possibility of being manipulated or altered.

29. The system according to claim 28, wherein the broadcast means is configured to additionally send to one or more contacts a warning communication comprising at least one data selected from:
an indication of the existence of an accident involving the user,
an identification of the user involved in an accident,
a time of the accident,
an access to the location of the vehicle involved in the accident;
an access to the itinerary of the vehicle involved in the accident; and
an access to audiovisual recordings.

30. The system according to claim 28, further comprising a first capture device that integrates the accident sensors, the recording means and at least part of the broadcast means;
wherein the positioning means are intended to be contained in a mobile device of the user, with which the first capture device is communicated through communication means.

31. The system according to claim 30, wherein the first capture device is configured to be fixed to the vehicle.

32. The system according to claim 30, further comprising a second capture device comprising:
a mobile device of the user, with positioning means; and
integrated together with the mobile device of the user, the accident sensors, and the recording means.

33. The system according to claim 32, wherein the capture devices are configured to be fixed to a garment of the user.

34. The system according to claim 28, further comprising a mobile application intended to be installed on the mobile device of the user, which has access to various functionalities of said mobile device of the user, as well as has a user interface that interacts with the user, and communication with the server, to control the operation of the components, as well as to manage the emergency actions.
